(19) United States
(12) Patent Application Publication
(10) Pub. No.: US 2013/0121664 A1
(43) Pub. Date: May 16, 2013

(54) SYNOPSIS FRAMES AND MANUFACTURING METHOD THEREOF

(71) Applicant: NATIONAL CHENG KUNG UNIVERSITY, Tainan City (TW)

(72) Inventors: Pau-Choo CHUNG, Tainan City (TW); Chun-Rong HUANG, Tainan City (TW); Hsing-Cheng CHEN, Taipei City (TW)

(73) Assignee: NATIONAL CHENG KUNG UNIVERSITY, Tainan City (TW)

(21) Appl. No.: 13/662,563

(22) Filed: Oct. 29, 2012

(30) Foreign Application Priority Data
Nov. 11, 2011 (TW) 100141243

(51) Int. Cl. H04N 5/93

(52) U.S. Cl. 386/241; 386/E05.028

(57) ABSTRACT

A synopsis video includes a plurality of synopsis frames manufactured by using plural chronological source frames which include a plurality of foreground objects. Each of the foreground objects appearing in one of the synopsis frames just exists at one position of the synopsis frame. At least one portion of the foreground objects appearing in one of the synopsis frames originates from the source frames of different times. One of the foreground objects that originates from a later source frame appears in a later synopsis frame, and the foreground object that originates from a former source frame appears in a former synopsis frame.

### CROSS REFERENCE TO RELATED APPLICATIONS

This Non-provisional application claims priority under 35 U.S.C. §119(a) on Patent Application No(s). 100141243 filed in Taiwan, Republic of China on Nov. 11, 2011, the entire contents of which are hereby incorporated by reference.

### BACKGROUND OF THE INVENTION

1. Field of Invention

The invention relates to a manufacturing method of frames and, in particular, to synopsis frames and a manufacturing method thereof.

2. Related Art

In order to monitor environments, more and more cameras are disposed around and they are gradually equipped with higher quality. For completely recording the happenings, enormous storage capacity is needed for a long-time recording, and the stored information can be investigated later. Although the storage device is getting cheaper and cheaper, the storage capacity still can not be unlimitedly expanded. So, in order to record the new data, the oldest data must be covered by the newer one. Further, the image compression technology can be used to save the storage capacity, however, still with limited efficiency. Besides, it is really hard for the user to get effective information from a long-time recorded video, and even if the video is played with fast forward, the user only gets indefinite information from the video.

### SUMMARY OF THE INVENTION

In view of the foregoing subject, an objective of the invention is to provide synopsis frames and a manufacturing method thereof that can solve the problems of the conventional art.

To achieve the above objective, a manufacturing method of synopsis frames according to the invention comprises the steps of: receiving a first source frame; taking out at least one first foreground object from the first source frame; putting the first foreground object in a first synopsis frame; receiving a second source frame, which is later than the first source frame; taking out at least a second foreground object from the second source frame; and putting the second foreground object in the first synopsis frame if the second foreground object doesn't overlap the first foreground object in the first synopsis frame.

To achieve the above objective, a manufacturing method of synopsis frames according to the invention comprises the steps of: receiving a first source frame; taking out at least one first foreground object from the first source frame; putting the first foreground object in a first synopsis frame; receiving a second source frame, which is later than the first source frame; taking out at least a second foreground object from the second source frame; and putting the second foreground object in a second synopsis frame if the second foreground object overlaps the first foreground object in the first synopsis frame.

To achieve the above objective, a synopsis video according to the invention includes a plurality of synopsis frames manufactured by using plural chronological source frames which include a plurality of foreground objects. Each of the foreground objects appearing in one of the synopsis frames just exists at one position of the synopsis frame. At least one portion of the foreground objects appearing in one of the synopsis frames originates from the source frames of different times. One of the foreground objects that originates from a later source frame appears in a later synopsis frame, and the foreground object that originates from a former source frame appears in a former synopsis frame.

As mentioned above, in the synopsis frames and the manufacturing method thereof, the different foreground objects originating from the source frames of different times can be taken out and then be put in the same synopsis frame when they don't overlap with each other, so the frames can be condensed to produce the synopsis frames constituting a synopsis video. In the synopsis frames, the foreground objects are targeted, and the motions of the foreground objects are displayed in the synopsis video of a short time, increasing the use efficiency. For example, the police can view the synopsis video to investigate some people or something. The synopsis video also can be applied to surveillance monitoring and can reduce the required storage space. The synopsis frames can be made not only by using the stored video or scanning the whole video, but also by using the real-time video frames so as to achieve the on-line or real-time surveillance monitoring.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a flow chart of a manufacturing method of synopsis frames of a preferred embodiment of the invention;

FIGS. 2A to 2D are schematic diagrams of the possible source frames;

FIGS. 3A to 3C are schematic diagrams of the possible first synopsis frames;

FIGS. 4A to 4C are schematic diagrams of the possible second synopsis frames;

FIG. 5 is a flow chart of another manufacturing method of synopsis frames of a preferred embodiment of the invention;

FIGS. 6A to 6D are schematic diagrams of the possible source frames;

FIG. 7 is a schematic diagram of the possible first synopsis frame;

FIGS. 8A and 8B are schematic diagrams of the possible second synopsis frames; and

FIGS. 9A and 9B are schematic diagrams of the possible third synopsis frames.

### DETAILED DESCRIPTION OF THE INVENTION

The present invention will be apparent from the following detailed description, which proceeds with reference to the accompanying drawings, wherein the same references relate to the same elements.

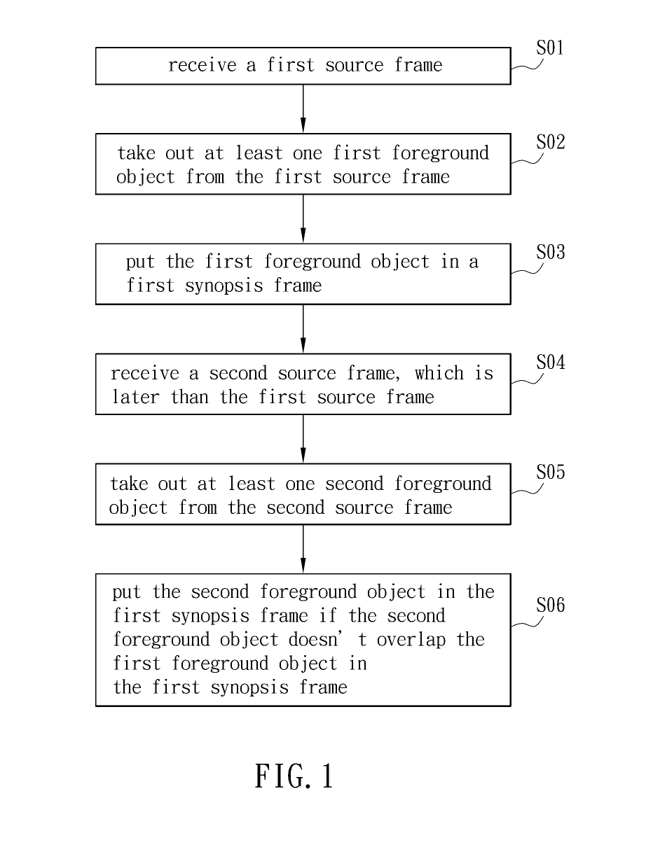

FIG. 1 is a flow chart of a manufacturing method of synopsis frames of a preferred embodiment of the invention, including the steps S01 to S06.

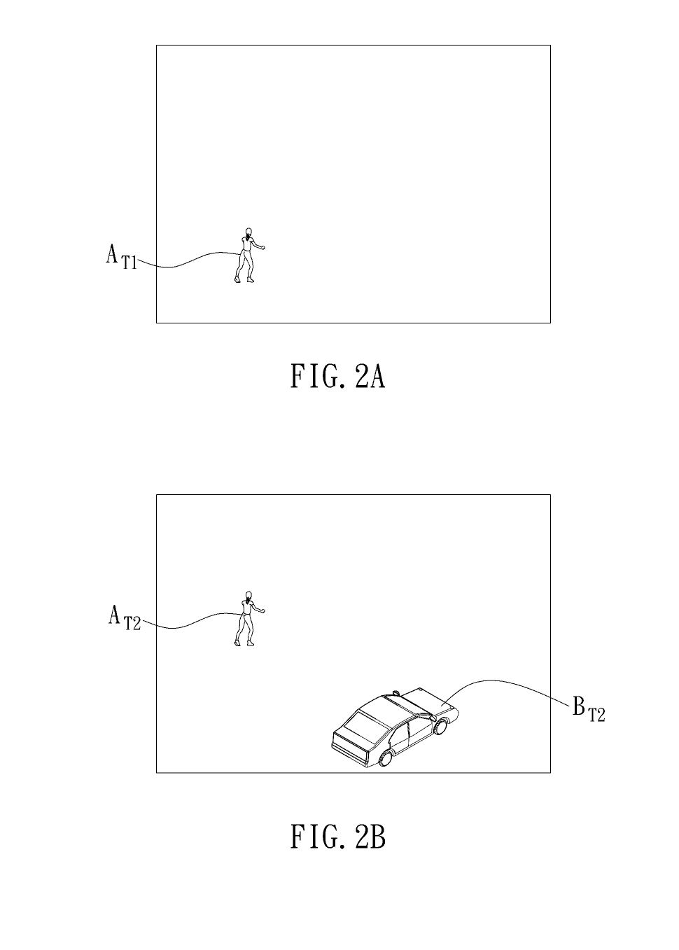

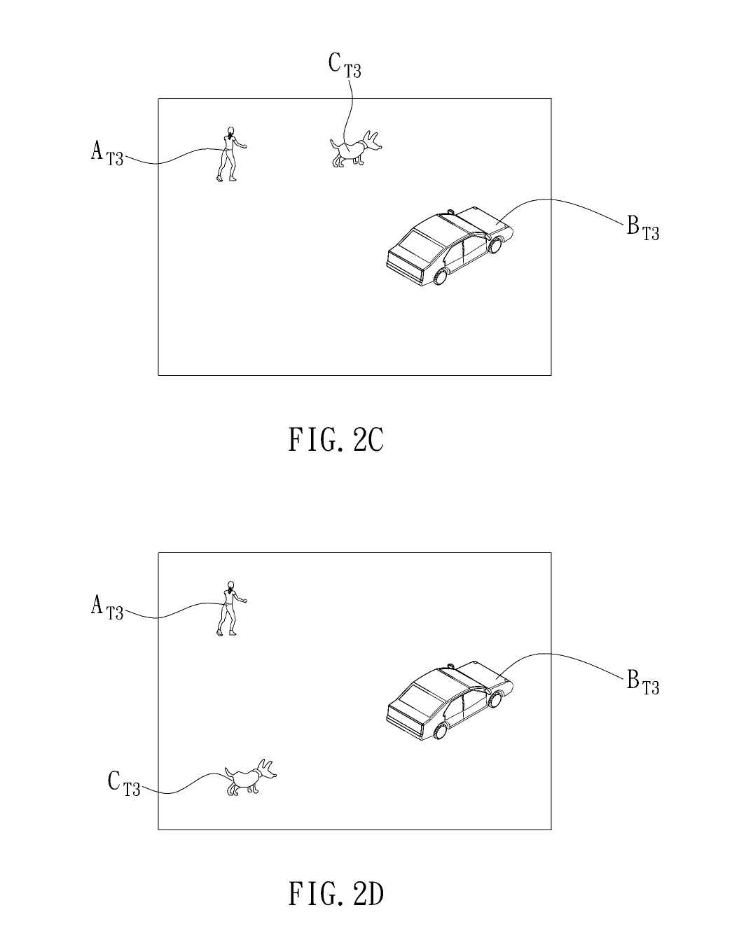

First, the step S01 is to receive a first source frame. The first source frame can be, for example, a certain frame of a surveillance video. The surveillance video can be a real-time recorded video or a stored video that has been made before. FIG. 2A schematically shows a possible first source frame.

The step S02 is to take out at least one first foreground object from the first source frame. By the image analysis, a frame can be divided into a foreground portion and a background portion. The foreground portion usually represents active objects, and the background portion represents inactive objects. To be noted, the active level of the foreground and the inactive level of the background can be defined based on the analysis requirement. Since the analyses of the foreground and background belong to the conventional art, they are omitted here. The first source image includes a first foreground object A_{T1} (such as a human), wherein “A” represents the individuality of the foreground object, and “T1” represents that the foreground object A originates from the source frame of the time T1.

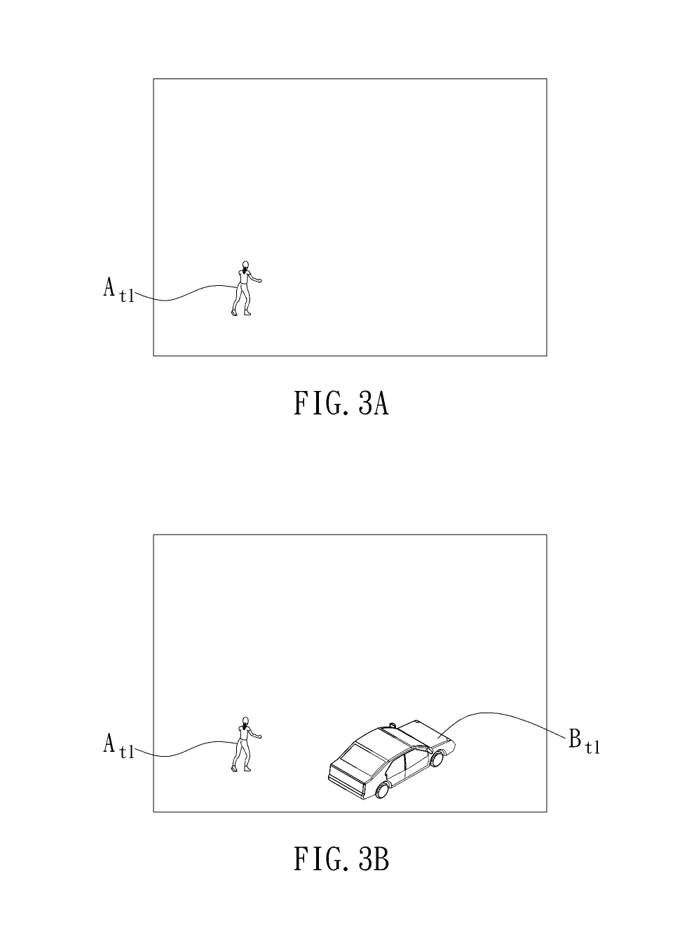

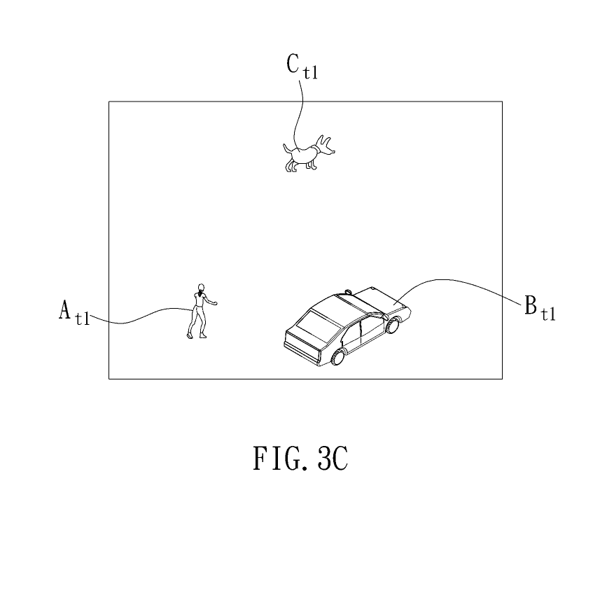

The step S03 is to put the first foreground object A_{T1} in a first synopsis frame. The synopsis frame is made by using the source frames, different from the source frame but regarded as the condensation of the source frames. However, the synopsis frame doesn't lose the representative meaning of the source frames. Therefore, the synopsis frame can be regarded as the “synopsis” of the source frames. FIG. 3A is a schematic diagram of the first synopsis frame. Because the synopsis frame just began to be made, the first synopsis frame is almost the same as the first source frame. For example, the position of the first foreground object A_{T1} is the same as that of the first foreground object Aₜ₁, and the definition or the pixel array of the first synopsis frame is the same as that of the first source frame. However, to be noted, in the first synopsis frame, the numeral of the first foreground object is changed to Aₜ₁, wherein “t1” represents the time of the first synopsis frame.

The step S04 is to receive a second source frame, which is later than the first source frame. The second source frame is one of the frames later than the first source frame in the video, but not necessarily next to the first source frame. FIG. 2B is a schematic diagram of a possible second source frame. To be noted, in the embodiment, because the first and second source frames originate from the same surveillance video or the monitor of the same brand, the borders (represented by the definition or pixel array for example) of them are also the same, which facilitates the manufacturing of the synopsis frames.

The step S05 is to take out at least one second foreground object from the second source frame. Herein, the second source frame includes a second foreground object B_{T2} (such as a car), wherein “B” is the numeral of the foreground object, and “T2” represents that the foreground object B originates from the source frame of the time T2. To be noted, the second foreground object B_{T2} represents the object different from the foreground object A.

The step S06 is to put the second foreground object B_{T2} in the first synopsis frame if the second foreground object B_{T2} doesn't overlap the first foreground object Aₜ₁ in the first synopsis frame. Referring to FIGS. 2B and 3A, because the second foreground object B_{T2} doesn't overlap the first foreground object Aₜ₁ in the first synopsis frame, the second foreground object B_{T2} is put in the first synopsis frame so that the first synopsis frame is changed to the diagram as shown in FIG. 3B, in which the second foreground object's numeral is thus changed to Bₜ₁ to represent the appearance in the first synopsis frame of the time t1. Accordingly, the position of the second foreground object B_{T2} in the second source frame is substantially or completely the same as that of the second foreground object Bₜ₁ in the first synopsis frame. To be noted, the above-mentioned “overlap” represents the two foreground objects are superimposed at least in partial pixels. As to how many overlapped pixels sufficient to mean the “overlap” depends on the image analysis requirement. For example, for the police investigation requiring higher accuracy, the required overlapped pixels can be increased, but, however, this will possibly increase the amount of the synopsis frames.

So far, the two different foreground objects originate from the source frames of different times (T1 and T2) are put in the synopsis frame of the same time (t1), achieving the purposes of condensation and synopsis.

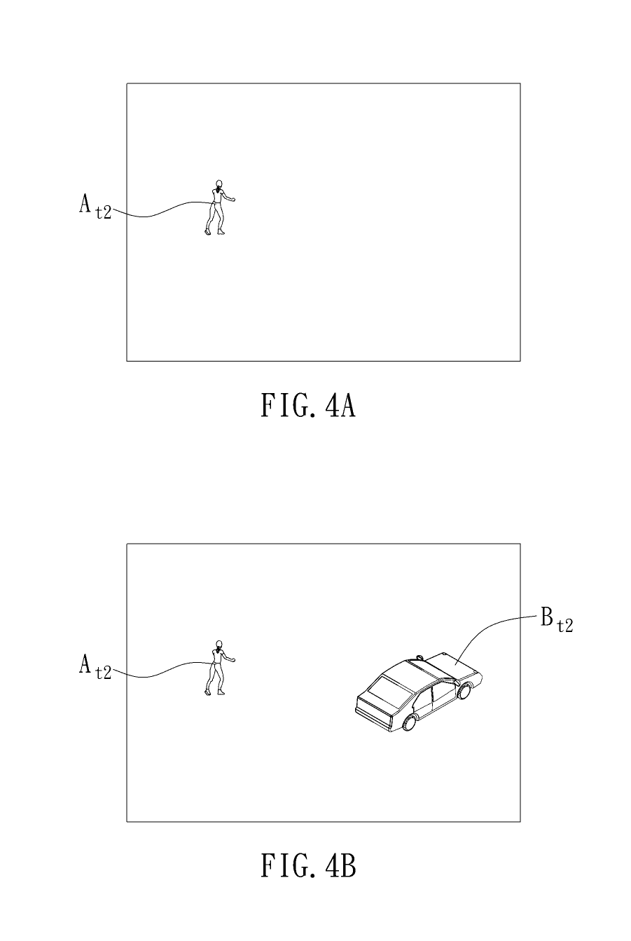

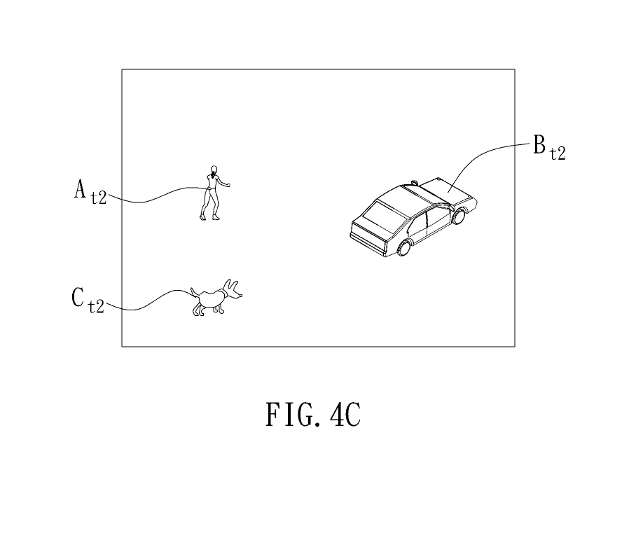

The manufacturing method of the synopsis frames can further include the step of: taking out the first foreground object from the second source frame, and putting the first foreground object in a second synopsis frame. In the second source frame as shown in FIG. 2B, there is still the first foreground object A_{T2}, which is put in a second synopsis frame as shown in FIG. 4A, in which the first foreground object's numeral is changed to Aₜ₂ to represent the appearance in the second synopsis frame.

The manufacturing method of the synopsis frames can further include the step of: taking out the second foreground object from a third source frame, and putting the second foreground object in the second synopsis frame. Herein, FIG. 2C is a schematic diagram of the third source frame, in which the second synopsis foreground object B_{T3} is taken out and then put in the second synopsis frame so that the second synopsis frame is changed to the diagram as shown in FIG. 4B, in which the second foreground object's numeral is changed to Bₜ₂ to represent the appearance in the second synopsis frame of the time t2. Therefore, the synopsis frame provides the effectiveness of condensation and synopsis again.

Since the third source frame further includes a third foreground object C_{T3}, the manufacturing method of the synopsis frames can further include the step of: taking out a third foreground object from a third source frame, and putting the third foreground object in the first synopsis frame if the third foreground object doesn't overlap the first foreground object in the first synopsis frame. Referring to the third source frame as shown in FIG. 2C and the first synopsis frame as shown in FIG. 3B, because the third foreground object C_{T3} doesn't overlap the first foreground object Aₜ₁ in the first synopsis frame and the third foreground object C_{T3} doesn't overlap the second foreground object Bₜ₁ in the first synopsis frame, the third foreground object C_{T3} is put in the first synopsis frame so that the first synopsis frame is changed to the diagram as shown in FIG. 3C, in which the third foreground object's numeral is changed to Cₜ₁ to represent the appearance in the first synopsis frame of the time t1. Therefore, the synopsis frame provides the effectiveness of condensation and synopsis again.

As to the third foreground object, there are some different cases. Referring to another case of the third source frame as shown in FIG. 2D, the manufacturing method of the synopsis frames can further include the step of: putting the third foreground object in the second synopsis frame if the third foreground object overlaps the first foreground object in the first synopsis frame but doesn't overlap the first foreground object or the second foreground object in the second synopsis frame. Referring to the third source frame as shown in FIG. 2D, the first synopsis frame as shown in FIG. 3B, and the second synopsis frame as shown in FIG. 4B, because the third foreground object C_{T3} overlaps the first foreground object Aₜ₁ in the first synopsis frame, the third foreground object C_{T3} can not be put in the first synopsis frame. But, the third foreground object C_{T3} doesn't overlap the first foreground object Aₜ₂ or the second foreground object Bₜ₂ in the second synopsis frame, so the third foreground object C_{T3} is put in the second synopsis frame so that the second synopsis frame is changed to the diagram as shown in FIG. 4C, in which the third foreground object's numeral is changed to Cₜ₂ to represent the appearance in the first synopsis frame of the time t2.

Regarding another case, if the third foreground object overlaps the first foreground object Aₜ₁ in the first synopsis frame and overlaps the first foreground object Aₜ₂ or the second foreground object Bₜ₂ in the second synopsis frame, the third foreground object will be put in a third synopsis frame with a numeral Cₜ₃ to represent the appearance in the third synopsis frame (not shown) of the time t3.

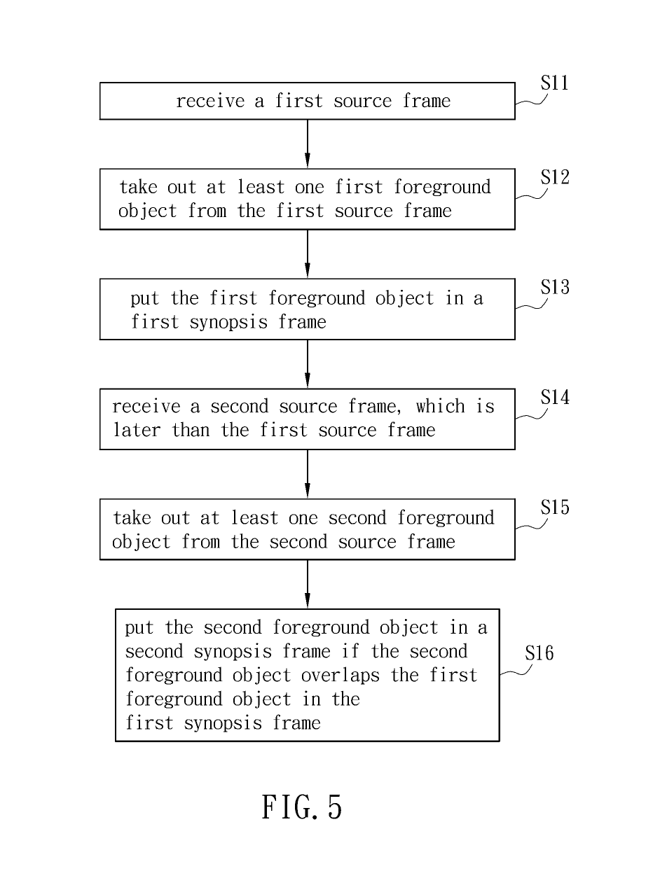

FIG. 5 is a flow chart of another manufacturing method of synopsis frames, including the steps S11 to S16.

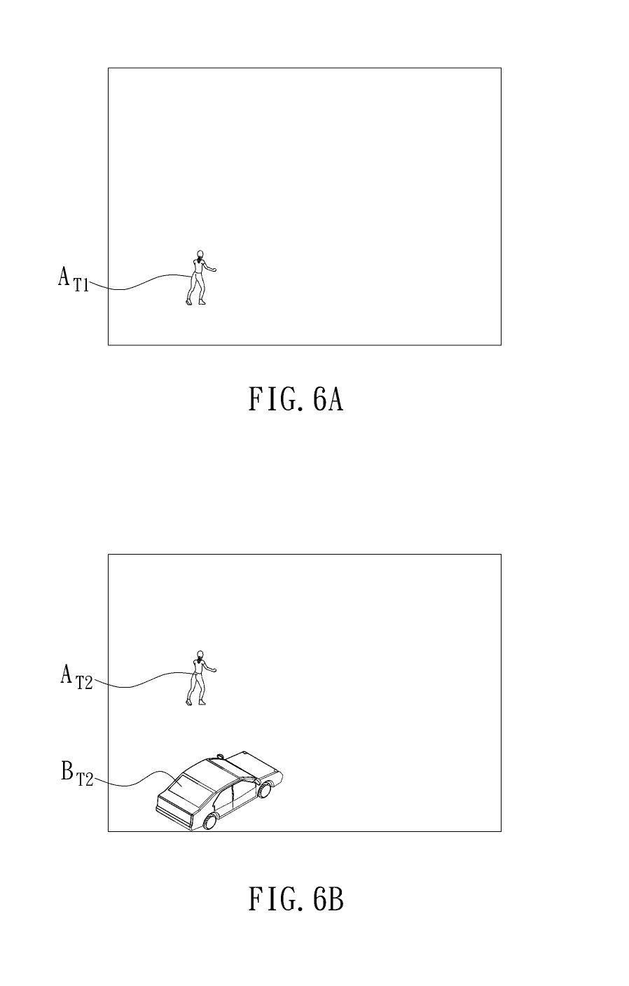

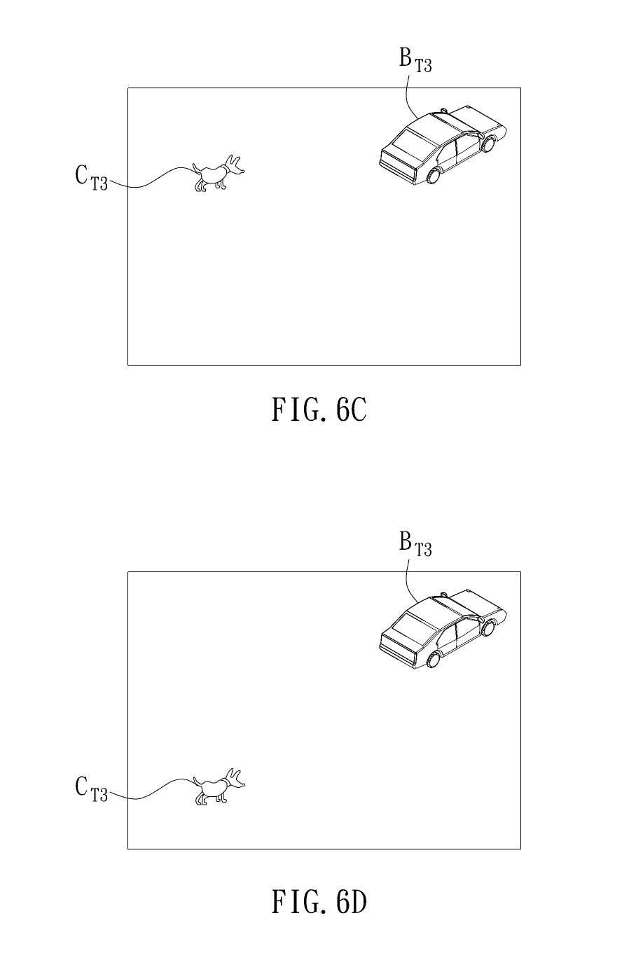

First, the step S11 is to receive a first source frame. FIG. 6A is a schematic diagram of a possible first source frame.

The step S12 is to take out at least one first foreground object from the first source frame. Herein, the first source frame includes a first foreground object A_{T1} (such as a human).

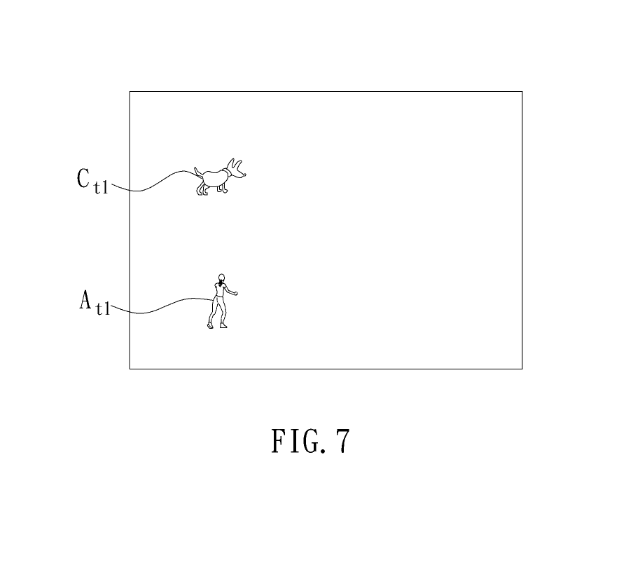

The step S13 is to put the first foreground object A_{T1} in a first synopsis frame as shown in FIG. 7.

The step S14 is to receive a second source frame, which is later than the first source frame. FIG. 6B is a schematic diagram of a possible second source frame.

The step S15 is to take out at least one second foreground object from the second source frame. Herein, the second source frame includes a second foreground object B_{T2} (such as a car).

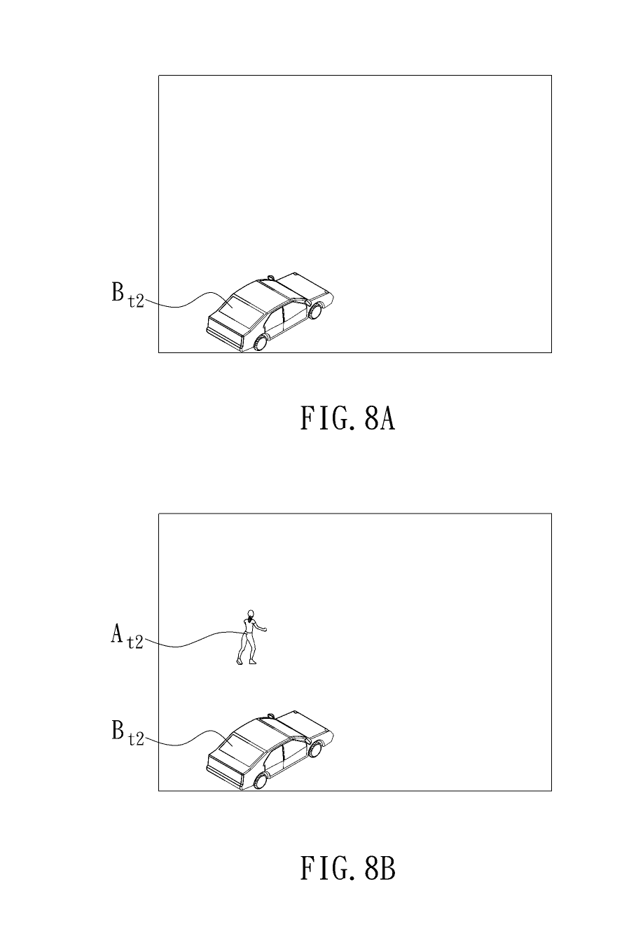

The step S16 is to put the second foreground object in a second synopsis frame if the second foreground object B_{T2} overlaps the first foreground object Aₜ₁ in the first synopsis frame. Referring to the second source frame as shown in FIG. 6B and the first synopsis frame as shown in FIG. 7, because the second foreground object BT2 overlaps the first foreground object Aₜ₁ in the first synopsis frame, the second foreground object is put in a second synopsis frame as shown in FIG. 8A, in which the second foreground object's numeral is changed to Bₜ₂ to represent the appearance in the second synopsis frame of the time t2.

The manufacturing method of the synopsis frames can further include the step of: taking out the first foreground object from the second source frame, and putting the first foreground object in the second synopsis frame so that the second synopsis frame is changed to the diagram as shown in FIG. 8B, in which the first foreground object's numeral is changed to Aₜ₂ to represent the appearance in the second synopsis frame of the time t2.

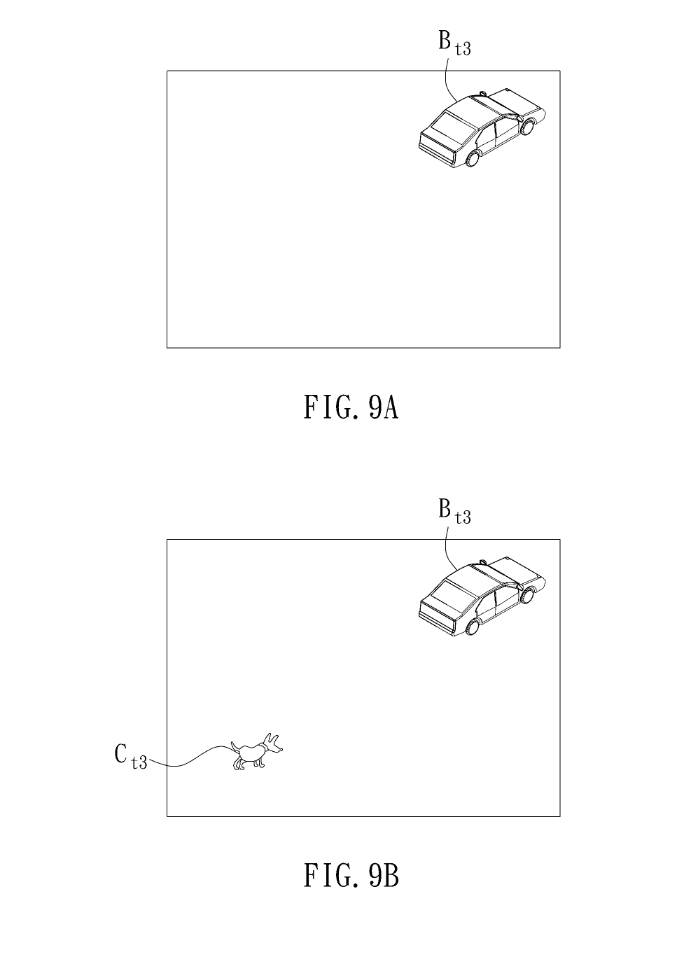

The manufacturing method of the synopsis frames can further include the step of: taking out the second foreground object from a third source frame, and putting the second foreground object in a third synopsis frame. FIG. 6C is a schematic diagram of a possible third source frame. The third source frame is later than the second source frame, but not necessarily next to the second source frame. FIG. 9A is a schematic diagram of the third synopsis frame, in which the second foreground object is put with a modified numeral Bₜ₃ to represent the appearance in the third synopsis frame of the time t3.

The manufacturing method of the synopsis frames can further include the step of: taking out a third foreground object C_{T3} from a third source frame, and putting the third foreground object C_{T3} in the first synopsis frame if the third foreground object C_{T3} doesn't overlap the first foreground object Aₜ₁ in the first synopsis frame. Referring to the third source frame as shown in FIG. 6C and the first synopsis frame as shown in FIG. 7, because the third foreground object C_{T3} doesn't overlap the first foreground object Aₜ₁ in the first synopsis frame, the third foreground object C_{T3} is put in the first synopsis frame with a modified numeral Cₜ₁ to represent the appearance in the first synopsis frame of the time t1.

As to the third foreground object C_{T3}, there are some different cases. For example, if the third foreground object C_{T3} overlaps the first foreground object Aₜ₁ in the first synopsis frame but doesn't overlap the first foreground object Aₜ₂ and the second foreground object Bₜ₂ in the second synopsis frame, the third foreground object C_{T3} is put in the second synopsis frame (not shown).

Otherwise, if the third foreground object C_{T3} overlaps the first foreground object Aₜ₁ in the first synopsis frame, and overlaps the first foreground object Aₜ₂ or the second foreground object Bₜ₂ in the second synopsis frame, but doesn't overlap the second foreground object Bₜ₃ in the third synopsis frame, the third foreground object C_{T3} is put in the third synopsis frame. FIG. 6D is a schematic diagram of a possible third source frame. Referring to the third source frame as shown in FIG. 6D, the first synopsis frame as shown in FIG. 7, the second synopsis frame as shown in FIG. 8B, and the third synopsis frame as shown in FIG. 9A, because the third foreground object C_{T3} overlaps the first foreground object Aₜ₁ in the first synopsis frame, and overlaps the first foreground object Aₜ₂ or the second foreground object Bₜ₂ in the second synopsis frame, but doesn't overlap the second foreground object Bₜ₃ in the third synopsis frame, the third foreground object C_{T3} is put in the third synopsis frame so that the third synopsis frame is changed to the diagram as shown in FIG. 9B, in which the third foreground object's numeral is changed to Cₜ₃ to represent the appearance in the third synopsis frame of the time t3.

To be noted, the above-mentioned two manufacturing methods of the synopsis frames have the same principle with just two different cases. By the principle, a series of synopsis frames can be made to constitute a synopsis video. The synopsis video provides the information contained in the source video for the user in a way of condensation and synopsis so that the user can obtain the required information in a short time. Besides, the synopsis frames can be linked to the source frames so that the user can link the source video, according to the targeted foreground object, to obtain more information when viewing the synopsis video.

The synopsis frames and the synopsis video provided by the above-mentioned methods are at least characterized by:

1. Each of the foreground objects appearing in one of the synopsis frames only exits at a position of the synopsis frame.

2. At least a portion of the foreground objects appearing in one of the synopsis frames originates from the source frames of different times.

3. A foreground object that originates from a later source frame appears in a later synopsis frame, and the foreground object that originates from a former source frame appears in a former synopsis frame.

The synopsis frames and the synopsis video are also characterized by, for example, that a foreground object's position in the synopsis frame is substantially or completely the same as the foreground object's position in the source frame.

In summary, in the synopsis frames and the manufacturing method thereof, the different foreground objects originating from the source frames of different times can be taken out and then be put in the same synopsis frame when they don't overlap with each other, so the frames can be condensed to produce the synopsis frames constituting a synopsis video. In the synopsis frames, the foreground objects are targeted, and the motions of the foreground objects are displayed in the synopsis video of a short time, increasing the use efficiency. For example, the police can view the synopsis video to investigate some person or some thing. The synopsis video also can be applied to home surveillance and can reduce the required storage space. The synopsis frames can be made not only by using the stored video or scanning the whole video, but also by using the real-time video frames so as to achieve the on-line or real-time surveillance.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A manufacturing method of synopsis frames, comprising the steps of:
receiving a first source frame;
taking out at least one first foreground object from the first source frame;
putting the first foreground object in a first synopsis frame;
receiving a second source frame, which is later than the first source frame;
taking out at least a second foreground object from the second source frame; and
putting the second foreground object in the first synopsis frame if the second foreground object doesn't overlap the first foreground object in the first synopsis frame.

2. The manufacturing method of synopsis frames as recited in claim 1, further comprising the step of:
taking out the first foreground object from the second source frame, and putting the first foreground object in a second synopsis frame.

3. The manufacturing method of synopsis frames as recited in claim 2, further comprising the steps of:
taking out a third foreground object from a third source frame, and putting the third foreground object in the first synopsis frame if the third foreground object doesn't overlap the first foreground object in the first synopsis frame;
putting the third foreground object in the second synopsis frame if the third foreground object overlaps the first foreground object in the first synopsis frame but doesn't overlap the first foreground object or the second foreground object in the second synopsis frame; and
putting the third foreground object in a third synopsis frame if the third foreground object overlaps the first foreground object in the first synopsis frame and overlaps the first foreground object or the second foreground object in the second synopsis frame.

4. The manufacturing method of synopsis frames as recited in claim 2, further comprising the step of:
taking out the second foreground object from a third source frame, and putting the second foreground object in the second synopsis frame.

5. The manufacturing method of synopsis frames as recited in claim 4, further comprising the steps of:
taking out a third foreground object from a third source frame, and putting the third foreground object in the first synopsis frame if the third foreground object doesn't overlap the first foreground object in the first synopsis frame;
putting the third foreground object in the second synopsis frame if the third foreground object overlaps the first foreground object in the first synopsis frame but doesn't overlap the first foreground object or the second foreground object in the second synopsis frame; and
putting the third foreground object in a third synopsis frame if the third foreground object overlaps the first foreground object in the first synopsis frame and overlaps the first foreground object or the second foreground object in the second synopsis frame.

6. The manufacturing method of synopsis frames as recited in claim 1, wherein the borders of the first source frame and the second source frame are the same.

7. A manufacturing method of synopsis frames, comprising the steps of:
receiving a first source frame;
taking out at least one first foreground object from the first source frame;
putting the first foreground object in a first synopsis frame;
receiving a second source frame, which is later than the first source frame;
taking out at least a second foreground object from the second source frame; and
putting the second foreground object in a second synopsis frame if the second foreground object overlaps the first foreground object in the first synopsis frame.

8. The manufacturing method of synopsis frames as recited in claim 7, further comprising the steps of:
taking out the first foreground object from the second source frame, and putting the first foreground object in the second synopsis frame.

9. The manufacturing method of synopsis frames as recited in claim 8, further comprising the steps of:
taking out a third foreground object from a third source frame, and putting the third foreground object in the first synopsis frame if the third foreground object doesn't overlap the first foreground object in the first synopsis frame;
putting the third foreground object in the second synopsis frame if the third foreground object overlaps the first foreground object in the first synopsis frame but doesn't overlap the first foreground object and the second foreground object in the second synopsis frame; and
putting the third foreground object in a third synopsis frame if the third foreground object overlaps the first foreground object in the first synopsis frame, and overlaps the first foreground object or the second foreground object in the second synopsis frame, but doesn't overlap the second foreground object in the third synopsis frame.

10. The manufacturing method of synopsis frames as recited in claim 8, further comprising the step of:
taking out the second foreground object from a third source frame, and putting the second foreground object in a third synopsis frame.

11. The manufacturing method of synopsis frames as recited in claim 10, further comprising the steps of:
taking out a third foreground object from the third source frame, and putting the third foreground object in the first synopsis frame if the third foreground object doesn't overlap the first foreground object in the first synopsis frame;
putting the third foreground object in the second synopsis frame if the third foreground object overlaps the first foreground object in the first synopsis frame but doesn't overlap the first foreground object and the second foreground object in the second synopsis frame; and
putting the third foreground object in the third synopsis frame if the third foreground object overlaps the first foreground object in the first synopsis frame, and overlaps the first foreground object or the second foreground object in the second synopsis frame, but doesn't overlap the second foreground object in the third synopsis frame.

12. The manufacturing method of synopsis frames as recited in claim 7, wherein the borders of the first source frame and the second source frame are the same.

13. A synopsis video including a plurality of synopsis frames manufactured by using plural chronological source frames which include a plurality of foreground objects, wherein each of the foreground objects appearing in one of the synopsis frames just exists at one position of the synopsis frame, at least one portion of the foreground objects appearing in one of the synopsis frames originates from the source frames of different times, and one of the foreground objects that originates from a later source frame appears in a later synopsis frame, and the foreground object that originates from a former source frame appears in a former synopsis frame.
